(19) United States
(12) Patent Application Publication
(10) Pub. No.: US 2020/0221036 A1
(43) Pub. Date: Jul. 9, 2020

(54) NON-OPTICAL ELECTRONIC IMAGING LENS CAMERA APPARATUS, METHOD, AND A PROCESS THEREOF

(71) Applicant: John T. Walicki, Poughkeepsie, NY (US)

(72) Inventor: John T. Walicki, Poughkeepsie, NY (US)

(21) Appl. No.: 16/737,872

(22) Filed: Jan. 8, 2020

Related U.S. Application Data
(60) Provisional application No. 62/790,240, filed on Jan. 9, 2019.

(51) Int. Cl. H04N 5/232; H04N 5/225

(52) U.S. Cl. CPC H04N 5/232933; H04N 5/2252

(57) ABSTRACT

The present invention relates generally to a non-optical electronic imaging lens camera apparatus, method, and a process thereof. More particularly, the invention encompasses an electronic imaging lens camera or a “lens less” camera where an image or a photograph is taken without the use of any glass-type optical lens. An important aspect of this invention is the use of a non-optical electronic imaging lens camera, to obtain a digital or electronic image, using at least two or more individual non-optical sensors.

### CROSS-REFERENCE TO RELATED APPLICATION

The instant patent application claims priority to and the benefit of pending U.S. Provisional Patent Application Ser. No. 62/790,240, filed on Jan. 9, 2019, titled “NON-OPTICAL ELECTRONIC IMAGING LENS CAMERA APPARATUS, METHOD, AND A PROCESS THEREOF,” the entire disclosure of which provisional application is incorporated herein by reference.

### FIELD OF THE INVENTION

The present invention relates generally to a non-optical electronic imaging lens camera apparatus, method, and a process thereof. More particularly, the invention encompasses an electronic imaging lens camera or a “lens less” camera where an image or a photograph is taken without the use of any glass-type optical lens. An important aspect of this invention is the use of a non-optical electronic imaging lens camera, to obtain a digital or electronic image, using at least two or more individual non-optical sensors.

### BACKGROUND INFORMATION

Cameras having optical or glass-type lenses have been used in the industry for a variety of reasons, and they come in many shapes, sizes, and other physical features and attributes.

This invention improves on the deficiencies of the prior an and provides an inventive non-optical electronic imaging lens camera apparatus, method, and a process thereof.

### PURPOSES AND SUMMARY OF THE INVENTION

The invention is a novel non-optical electronic imaging lens camera apparatus, method, and a process thereof.

Therefore, one purpose of this invention is to provide a non-optical electronic imaging lens camera apparatus, method, and a process thereof.

Another purpose of this invention is to use a non-optical electronic imaging lens camera, to obtain a digital or electronic image, using at least two or more individual non-optical sensors.

Therefore, in one aspect this invention comprises a non-optical electronic imaging lens camera apparatus, comprising:
(a) a housing having a first side, a second side, and a peripheral side, and wherein said peripheral side is between said first side, and said second side;
(b) at least one sensor panel array having at least one first individual non-optical sensor, and at least one second individual non-optical sensor secured to said first side of said housing for receiving one of light and radiant energy; and
(c) at least one imaging screen is secured to said second side of said housing, and wherein at least one internal electronics are contained inside said housing between said first side and said second side to form a non-optical electronic imaging lens camera apparatus.

In another aspect this invention comprises a non-optical electronic imaging lens camera apparatus, comprising:
(a) a housing having a first side, a second side, and a peripheral side, and wherein said peripheral side is between said first side, and said second side;
(b) at least one sensor panel array having at least one first individual non-optical sensor, and at least one second individual non-optical sensor secured to said first side of said housing for receiving, one of light and radiant energy;
(c) at least one imaging screen is secured to said second side of said housing, and wherein at least one internal electronics are contained inside said housing between said first side and said second side to form a non-optical electronic imaging lens camera apparatus; and
(d) wherein one of said at least one first individual non-optical sensor, and said at least one second individual non-optical sensor is selected from a group consisting of a Red Laser (RL), an Indigo LED (Light Emitting Diode) (I), a Photovoltaic Sensor (PV), a Green Laser (GL), an Ultraviolet LED (UV), a Pressure Sensor (PS), an Infrared LED (IR), a Blue LED (B), a Green LED (G), a Heat Sensor (HS), a White LED (W), a Red LED (R), a Motion Sensor (MS), an Orange LED (O), a Yellow Led (Y), and combinations thereof.

In yet another aspect this invention comprises a non-optical electronic imaging lens camera apparatus, comprising:
(a) a housing having a first side, a second side, and a peripheral side, and wherein said peripheral side is between said first side, and said second side;
(b) at least one sensor panel array having at least one first individual non-optical sensor, and at least one second individual non-optical sensor secured to said first side of said housing for receiving one of light and radiant energy;
(c) means to access and determine the voltage of each sensor in said sensor array to provide a first digital signal;
(d) means for storing said first digital signals from said sensor array, and
(e) means to access and apply a voltage on each emitter in at least one display screen to create an image from said first signal onto said at least one display screen; and
(f) wherein said at least one display screen is secured to said second side of said housing, and wherein at least one internal electronics are contained inside said housing between said first side and said second side to form a non-optical electronic imaging lens camera apparatus.

### BRIEF DESCRIPTION OF THE DRAWINGS

FIG. 1, shows a typical emitter.

FIG. 2, shoves a typical receptor.

FIG. 3, shows a first embodiment of a non-optical electronic imaging lens camera invention.

FIG. 4, shows a second embodiment of a non-optical electronic imaging lens camera invention.

FIG. 5, shows a third embodiment of a non-optical electronic imaging lens camera invention.

FIG. 6, shows a fourth embodiment of a non-optical electronic imaging lens camera invention.

### DETAILED DESCRIPTION

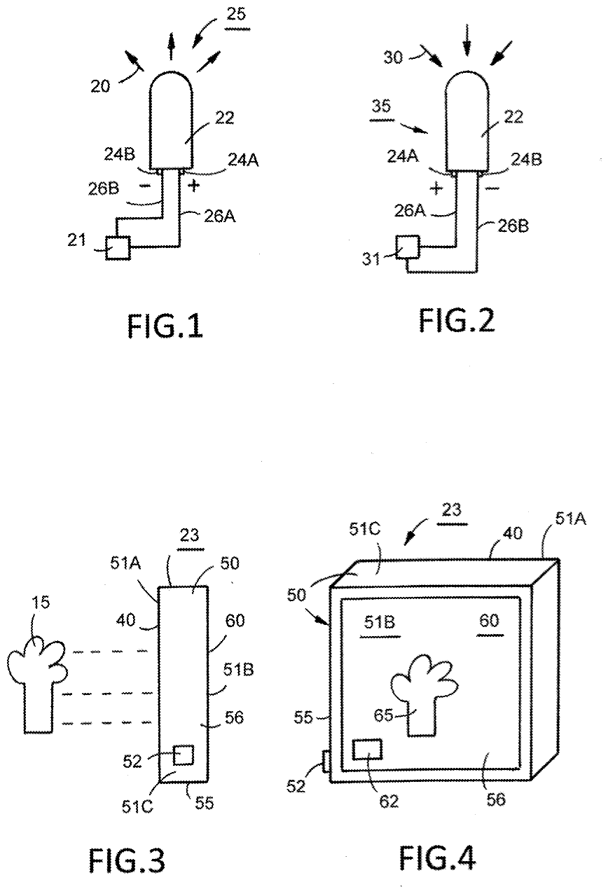

The inventive non-optical electronic imaging lens camera apparatus, method, and a process thereof will now be discussed with reference to FIGS. 1 through 6. Although the scope of the present invention is much broader than any particular embodiment, a detailed description of the preferred embodiment follows together with drawings. These drawings are for illustration purposes only and are not drawn to scale. Like numbers represent like features and components in the drawings.

The invention is a non-optical electronic imaging lens camera apparatus, method, and a process thereof, and more particularly directed to an electronic imaging lens camera or a “lens less” camera where an image or a photograph is taken without the use of any glass-type optical lens.

FIG. 1, shows a typical emitter 25, comprising of an LED (Light Emitting Diode) 22, and having a first or positive terminal 24A, and a second or a negative terminal 24B. A battery 21, is then electrically connected to the LED 22, using a first wire or positive connection 26A, to the positive terminal 24A, and a second wire or negative connection 26B, to the negative terminal 248. The battery 21, is then activated, and which results in the LED 22, being activated, and then light emission 20, is then generated. The light emission 20, will continue until the battery 21, is turned-off, or the battery 21, is depleted of its stored power. The LED 22, will emit light emission 20, based on the configuration of the LED 22, so for example, if the LED 22, is a red LED 22, then it will emit red light 20, or if the LED 22, is a white light LED 22, then it would generate white light emission 20, etc.

FIG. 2, shows a typical receptor 35, comprising of an LED (Light Emitting Diode) 22, and having a first or positive terminal 24A, and a second or a negative terminal 24B. A voltmeter 31, is then electrically connected to the LED 22, using a first wire or positive connection 26A, to the positive terminal 24A, and a second wire or negative connection 26B, to the negative terminal 24B. A light 30, is then generated, and which light 30, is sensed by the LED 22, and this information is then sent to the voltmeter 31, which is electrically connected to an LED 22, via terminals 24A, 248, and wiring 26A, 268, and the intensity of light 30, is then displayed or shown or recorded in the voltmeter 31, and thus this results in the LED 22, becoming a receptor of light 30. It should be noted that the polarity of the circuit is reversed for the LED 22, when it is used as a receptor 35, from when the LED 22, is used as an emitter 25, such as, shown in FIG. 1.

Thus, as one can appreciate that an LED 22, can become a light emitter 25, under one set of conditions, as shown in FIG. 1, and a light receptor 35, in another set of conditions, as shown in FIG. 2. This is also known as bi-directional electric switching (BDES), which basically is a result of change of polarity of the LED 22, or similar electronic device 22, which is capable of operating after the change of polarity.

FIG. 3, shows a first embodiment of a non-optical electronic imaging lens camera 23, invention. The non-optical electronic imaging lens camera 21, comprises of at least one sensor panel array 40, which is contained on a first or front side 51A, of a housing 50, and at least one imaging screen 60, is contained on the second or back side 51B, of the housing 50. The housing 50, could optionally have one or more electronic buttons 52, such as, along a peripheral side 51C, of the housing 50, for at least one operation of the non-optical electronic imaging lens camera 23. A user (not shown) can point the non-optical electronic imaging lens camera 23, towards at least one object 15, such as, a physical object 15, to be imaged or photographed, such as, for example, a tree 15, or a structure 15, and then the at least one sensor panel array 40, would take the incoming image of the physical object 15, and process it via at least one internal electronics 55, and convert it into a digital or electronic image 65, and then display that image of the physical object 15, as an electronic or digital image 65, onto at least one screen 60. For some applications the at least one internal electronics 55, could also comprise of at least one Nano-computer interface switch 56.

FIG. 4, shows a second embodiment of a non-optical electronic imaging lens camera 23, invention. The non-optical electronic imaging lens camera 23, processes the image of a physical object 15, as shown in FIG. 3, and then using at least one internal electronics 55, the system then converts such as with an analog to digital converter the image of the at least one physical object 15, into an electronic or digital image 65, and shows or displays it on at least one screen 60, as a digital or electronic image 65. The at least one screen 60, could optionally have one or more buttons 62, that could be used to operate the non-optical electronic imaging lens camera 23. The at least one button 62, could be a touch sensitive button 62, an electronic button 62, a digital image button 62, a physical button 62, and combinations thereof, to name a few, to help or assist in operating the non-optical electronic imaging lens camera 23, and/or the viewing or manipulation of the at least one digital or electronic image 65.

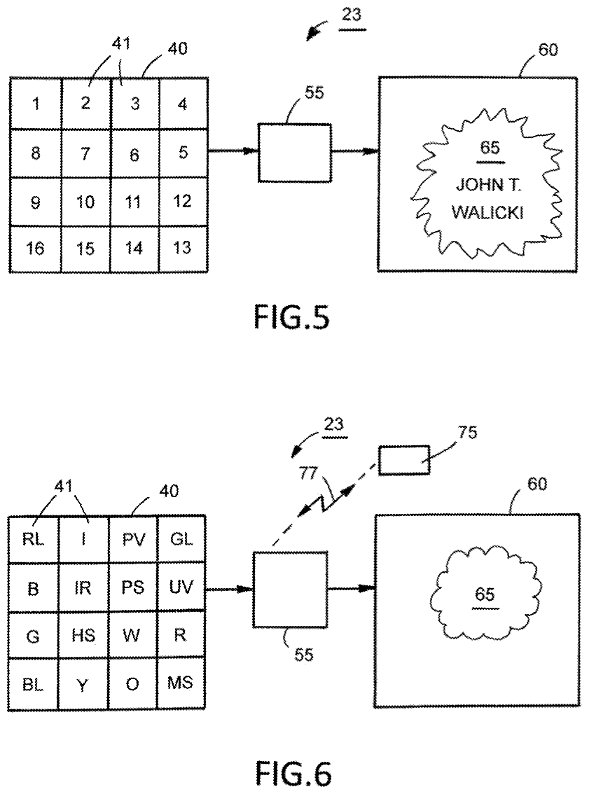

FIG. 5, shows a third embodiment of a non-optical electronic imaging lens camera 23, invention. The non-optical electronic imaging lens camera 23, has at least one panel array 40. The at least one panel array 40, could comprise of say, at least one array of sensors 41, in sensor panel array 40, and having a plurality of individual non-optical sensors 41. It should be appreciated that the sensor panel array 40, comprises of non-optical sensors 41, comprising visible and non-visible light and radiant energy sensors 41. For the purposes of illustration one could select one or more individual non-optical sensors 41, from a list of non-optical sensors 41, such as, for example:
1 Red Laser (RL) 41; and/or
2 Indigo LED (Light Emitting Diode) (I) 41; and/or
3 Photovoltaic Sensor (PV) 41; and/or
4 Green Laser (GL) 41; and/or
5 Ultraviolet LED (UV) 41; and/or
6 Pressure Sensor (PS) 41; and/or
7 Infrared LED (IR) 41; and/or
8 Blue LED (B) 41 and/or
9 Green LED (G) 41; and/or
10 Heat Sensor (HS) 41; and/or
11 White LED (W) 41; and/or
12 Red LED (R) 41; and/or
13 Motion Sensor (MS) 41; and/or
14 Orange LED (O) 41; and/or
15 Yellow Led (Y) 41; and/or
16 Blue Laser (BL) 41.

It should be appreciated that the image screen 60, acts as a reverse 16 bit sensor panel array 40, in order to take the physical image 15, obtained by the panel array 40, comprising of, for example, a 16 bit sensor panel array 40, and showing it as an electronic or digital image 65, on the image screen 60, using at least one internal electronics 55. It should be understood that the non-optical electronic imaging lens camera 23, could use two or more of the individual non-optical sensors 41, to create the electronic or digital image 65, however, using all the individual non-optical sensors 41, would result in a better quality digital or electronic image 65.

FIG. 6, shows a fourth embodiment of a non-optical electronic imaging lens camera 23, invention. The non-optical electronic imaging lens camera 23, has at least one panel array 40, such as, for example, at least one 16 bit sensor panel array 40, having a plurality of individual non-optical sensors 41, such as, for example, as illustrated in FIG. 5, however, it should be noted that the placement of the plurality of the individual non-optical sensors 41, could be random or as desired by a user or a manufacturer of the inventive non-optical electronic imaging lens camera 23. For the ease of understanding the layout of the individual non-optical sensors 41, in FIG. 6, corresponds to the layout shown in FIG. 5, and as listed with reference to FIG. 5, but this layout of the individual non-optical sensors 41, could comprise of two or more individual non-optical sensors 41, which could be either selected by a user or a manufacturer of the non-optical electronic imaging lens camera 23. An important aspect of this invention is the use of a non-optical electronic imaging lens camera 23, to obtain a digital or electronic image 65, using at least two or more individual non-optical sensors 41.

The at least one non-optical sensor 41, could be selected from a group comprising of a Red Laser (RL) 41, an Indigo LED (Light Emitting Diode) (I) 41, a Photovoltaic Sensor (PV) 41, a Green Laser (GL) 41, an Ultraviolet LED (UV) 41, a Pressure Sensor (PS) 41, an Infrared LED (IR) 41, a Blue LED (B) 41, a Green LED (G) 41, a Heat Sensor (HS) 41, a White LED (W) 41, a Red LED (R) 41, a Motion Sensor (MS) 41, an Orange LED (O) 41, a Yellow Led (Y) 41, and combinations thereof; to name a few. As one can appreciated that the at least one non-optical sensor array 40, comprises of different diodes 41, in the combination array 40. However, for some applications an optical lens 41, could also be used in the at least one non-optical sensor array 40, so as to optimize the image 65, being displayed on the digital display screen 60.

The tool used in the preset invention, namely, the non-optical electronic imaging lens camera 23, may be implemented using one or more internal computer or server 55, and/or one or more external computers or device or server 75, executing software instructions 55, 75, as illustrated in FIG. 6. According to one embodiment of the present invention, the non-optical electronic imaging lens camera 23, invention, may communicate with a server 55, 75, and/or a client computer systems 75, that transmit and receive data over a computer network 77, or a fiber or copper-based telecommunications network 77, or a Wi-Fi communication network 77, or a communication network 77, or a wireless communication network 77, and combinations thereof, to name a few. The steps of accessing, downloading, and manipulating the data, as well as other aspects of the present invention are implemented by central processing units (CPU) in the server 55, 75, and client computers executing sequences of instructions stored in a memory 55, 75. The memory 55, 75, may be a random access memory (RAM) 55, 75, read-only memory (ROM) 55, 75, a persistent store 55, 75, such as, a mass storage device 55, 75, or any combination of these devices 55, 75. Execution of the sequences of instructions causes the CPU or server 55, 75, to perform steps according to embodiments of the present invention.

The instructions may be loaded into the memory of the server or client computers 55, 75, from a storage device 55, 75, or from one or more other computer systems 55, 75, over a network connection 77. For example, a client computer 55, 75, may transmit a sequence of instructions to the server computer 55, 75, in response to a message transmitted to the client over a network 77, by the server 55, 75. As the server 55, 75, receives the instructions over the network connection 77, it stores the instructions in memory 55, 75. The server 55, 75, may store the instructions for later execution, or it may execute the instructions as they arrive over the network connection 77. In some cases, the CPU or server 55, 75, may directly support the downloaded instructions. In other cases, the instructions may not be directly executable by the CPU or server 55, 75, and may instead be executed by an interpreter that interprets the instructions. In other embodiments, hardwired circuitry may be used in place of, or in combination with, software instructions 55, 75, to implement the present invention. Thus tools used in the present invention are not limited to any specific combination of hardware circuitry and software, nor to any particular source for the instructions executed by the server or client computers 55, 75. In some instances, the client and server functionality may be implemented on a single computer platform 55, 75.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions, indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A non-optical electronic imaging lens camera apparatus, comprising:
(a) a housing having a first side, a second side, and a peripheral side, and wherein said peripheral side is between said first side, and said second side;
(b) at least one sensor panel array having at least one first individual non-optical sensor, and at least one second individual non-optical sensor secured to said first side of said housing for receiving one of light and radiant energy; and
(c) at least one imaging screen is secured to said second side of said housing, and wherein at least one internal electronics are contained inside said housing between said first side and said second side to form a non-optical electronic imaging lens camera apparatus.

2. The non-optical electronic imaging lens camera apparatus of claim 1, wherein said at least one first individual non-optical sensor is selected from a group consisting of a Red Laser (RL), an Indigo LED (Light Emitting Diode) (I), a Photovoltaic Sensor (PV), a Green Laser (GL), an Ultraviolet LED (UV), a Pressure Sensor (PS), an Infrared LED (IR), a Blue LED (B) a Green LED (G), a Heat Sensor (HS), a White LED (W), a Red LED (R), a Motion Sensor (MS), an Orange LED (O), a Yellow Led (Y), and combinations thereof.

3. The non-optical electronic imaging lens camera apparatus of claim 1, wherein said at least one second individual non-optical sensor is selected from a group consisting of a Red Laser (RL), an Indigo LED (Light Emitting Diode) (I), a Photovoltaic Sensor (PV), a Green Laser (GL), an Ultraviolet LED (UV), a Pressure Sensor (PS), an Infrared LED (IR), a Blue LED (B), a Green LED (G), a Heat Sensor (HS), a White LED (W), a Red LED (R), a Motion Sensor (MS), an Orange LED (O), a Yellow Led (Y), and combinations thereof.

4. The non-optical electronic imaging lens camera apparatus of claim 1, wherein said at least one first individual non-optical sensor is different that said at least one second individual non-optical sensor.

5. The non-optical electronic imaging lens camera apparatus of claim 1, wherein said at least one imaging screen has at least one button for operating said camera.

6. The non-optical electronic imaging lens camera apparatus of claim 1, wherein said at least one imaging screen has at least one button for operating said camera, and wherein said at least one button is selected from a group consisting of a touch sensitive button, an electronic button, a digital image button, a physical button, and combinations thereof.

7. The non-optical electronic imaging lens camera apparatus of claim 1, wherein said peripheral side of said housing has at least one button for operating said camera.

8. The non-optical electronic imaging lens camera apparatus of claim 1, wherein said peripheral side of said housing has at least one button, and wherein said at least one button is selected from a group consisting of a touch sensitive button, an electronic button, a digital image button, a physical button, and combinations thereof.

9. The non-optical electronic imaging lens camera apparatus of claim 1, wherein said non-optical electronic imaging lens camera apparatus has at least one internal electronics, and wherein said at least one internal electronics is adapted for coupling with at least one external computer.

10. The non-optical electronic imaging lens camera apparatus of claim 1, wherein said non-optical electronic imaging lens camera apparatus has at least one internal electronics, and wherein said at least one internal electronics is adapted for coupling with at least one external computer, using at least one communication network.

11. The non-optical electronic imaging lens camera apparatus of claim 1, wherein said non-optical electronic imaging lens camera apparatus has at least one internal electronics, and wherein said at least one internal electronics communicate with at least one external computer, using at least one communication network, and wherein said at least one communication network is selected form a group consisting of a fiber based communication network, a copper-based communication network, a Wi-Fi communication network, a communication network, a wireless communication network, and combinations thereof.

12. A non-optical electronic imaging lens camera apparatus, comprising:
(a) a housing having a first side, a second side, and a peripheral side, and wherein said peripheral side is between said first side, and said second side;
(b) at least one sensor panel array having at least one first individual non-optical sensor, and at least one second individual non-optical sensor secured to said first side of said housing for receiving one of light and radiant energy;
(c) at least one imaging screen is secured to said second side of said housing, and wherein at least one internal electronics are contained inside said housing between said first side and said second side to form a non-optical electronic imaging lens camera apparatus; and
(d) wherein one of said at least one first individual non-optical sensor, and said at least one second individual non-optical sensor is selected from a group consisting of a Red Laser (RL), an Indigo LED (Light Emitting Diode) (I), a Photovoltaic Sensor (PV), a Green Laser (GL), an Ultraviolet LED (UV), a Pressure Sensor (PS), an Infrared LED (IR), a Blue LED (B), a Green LED (G), a Heat Sensor (HS), a White LED (W), a Red LED (R), a Motion Sensor (MS), an Orange LED (O), a Yellow Led (Y), and combinations thereof.

13. The non-optical electronic imaging lens camera apparatus of claim 12, wherein said at least one imaging screen has at least one button for operating said camera.

14. The non-optical electronic imaging lens camera apparatus of claim 12, wherein said at least one imaging screen has at least one button, and wherein said at least one button for operating said camera is selected from a group consisting of a touch sensitive button, an electronic button, a digital image button, a physical button, and combinations thereof.

15. The non-optical electronic imaging lens camera apparatus of claim 12, wherein said peripheral side of said housing has at least one button for operating said camera.

16. The non-optical electronic imaging lens camera apparatus of claim 12, wherein said peripheral side of said housing has at least one button, and wherein said at least one button is selected from a group consisting of a touch sensitive button, an electronic button, a digital image button, a physical button, and combinations thereof.

17. The non-optical electronic imaging lens camera apparatus of claim 12, wherein said non-optical electronic imaging lens camera apparatus has at least one internal electronics, and wherein said at least one internal electronics communicate with at least one external computer.

18. The non-optical electronic imaging lens camera apparatus of claim 12, wherein said non-optical electronic imaging lens camera apparatus has at least one internal electronics, and wherein said at least one internal electronics communicate with at least one external computer, using at least one communication network.

19. The non-optical electronic imaging lens camera apparatus of claim 12, wherein said non-optical electronic imaging lens camera apparatus has at least one internal electronics, and wherein said at least one internal electronics communicate with at least one external computer, using at least one communication network, and wherein said at least one communication network is selected form a group consisting of a fiber based communication network, a copper-based communication network, a Wi-Fi communication network, a communication network, a wireless communication network, and combinations thereof.

20. A non-optical electronic imaging lens camera apparatus, comprising:
(a) a housing having a first side, a second side, and a peripheral side, and wherein said peripheral side is between said first side, and said second side;
(b) at least one sensor panel array having at least one first individual non-optical sensor, and at least one second individual non-optical sensor secured to said first side of said housing for receiving one of light and radiant energy;
(c) means to access and determine the voltage of each sensor in said sensor array to provide a first digital signal;
(d) means for storing said first digital signals from said sensor array, and
(e) means to access and apply a voltage on each emitter in at least one display screen to create an image from said first signal onto said at least one display screen; and
(f) wherein said at least one display screen is secured to said second side of said housing, and wherein at least one internal electronics are contained inside said housing between said first side and said second side to form a non-optical electronic imaging lens camera apparatus.
